(19) United States
(12) Patent Application Publication
(10) Pub. No.: US 2020/0086950 A1
(43) Pub. Date: Mar. 19, 2020

(54) Transmission for a Bicycle

(71) Applicant: ZF Friedrichshafen AG, Friedrichshafen (DE)

(72) Inventors: Uwe Griesmeier, Markdorf (DE); Johannes Kaltenbach, Friedrichshafen (DE); Valerie Engel, Markdorf (DE); Matthias Wesa, Ravensburg (DE)

(21) Appl. No.: 16/469,993

(22) PCT Filed: Nov. 24, 2017
(86) PCT No.: PCT/EP2017/080389

§ 371 Date: Jun. 14, 2019

(30) Foreign Application Priority Data
Dec. 15, 2016 (DE) 10 2016 225 157.0

(51) Int. Cl. B62M 11/18; B62M 6/55; B62M 11/14; F16H 3/64; F16H 37/04; F16H 37/02

(52) U.S. Cl. CPC B62M 11/18; B62M 6/55; B62M 11/145; F16H 3/64; F16H 37/042; F16H 37/02; F16H 2702/02; F16H 2200/0078; F16H 2200/2007; F16H 2200/201; F16H 2200/2082; F16H 2200/2048; F16H 2200/006

(57) ABSTRACT

A transmission for a bicycle includes a transmission input shaft (1) which is rotationally fixable to a crankshaft (2) and also includes first, second and third planetary gear sets (PS1, PS2, PS3) which are operatively connected to one another. An element of the first planetary gear set (PS1) is rotationally fixed to the transmission input shaft (1). The first planetary gear set includes a planet gear encompassing a first planetary gear stage (3) and a second planetary gear stage (5). A first ring gear (6) is engaged with a gear teeth section of the first planetary gear stage (3) and is rotationally fixable to a transmission housing (4) with a first shift element (s1). A second ring gear (7) is engaged with a gear teeth section of the second planetary gear stage (5) and is rotationally fixable to the transmission housing (4) with a second shift element (S2).

### FIELD OF THE INVENTION

The invention relates generally to a transmission for a bicycle that includes a transmission input shaft which is rotationally fixable to a crankshaft, a first planetary gear set, a second planetary gear set, and a third planetary gear set, which are operatively connected to one another. An element of the first planetary gear set is rotationally fixed to the transmission input shaft and the first planetary gear set includes a planet gear encompassing a first planetary gear stage and a second planetary gear stage.

The invention also relates generally to a bottom bracket transmission that includes such transmission. In addition, the invention relates generally to a bicycle that includes the transmission or the bottom bracket transmission.

### BACKGROUND

A multitude of transmissions which are utilized in bottom brackets of bicycles is known from the prior art. For example, a bottom bracket transmission is known from US 2011 177 911 A1, which includes three planetary transmissions connected in series. The planetary transmissions are designed in such a way that a speed increasing ratio is implemented. The transmission is a 12-speed bottom bracket transmission which, however, includes a total of seven planet gear planes, within which numerous stepped planetary gears are also located. The design complexity of the bottom bracket transmission is therefore high.

### SUMMARY OF THE INVENTION

Example aspects of the invention provide a transmission for a bicycle, which is simply designed and has low design complexity.

In example embodiments, a transmission includes a transmission input shaft which is rotationally fixable to a crankshaft, a first planetary gear set, a second planetary gear set, and a third planetary gear set, which are operatively connected to one another, an element of the first planetary gear set is rotationally fixed to the transmission input shaft and the first planetary gear set includes a planet gear encompassing a first planetary gear stage and a second planetary gear stage, and the transmission is characterized in that a first ring gear, which is engaged with a gear teeth section of the first planetary gear stage, is rotationally fixable to a transmission housing with the aid of a first shift element, and a second ring gear, which is engaged with a gear teeth section of the second planetary gear stage, is rotationally fixable to the transmission housing with the aid of a second shift element.

The transmission according to example aspects of the invention has the advantage that the planet gear is designed to be small. For example, the diameter in the case of a module of one (1) is less than eighty millimeters (80 mm). In addition, the diameters of the other planetary gear sets can likewise be kept small, and so the transmission is designed to be compact. In addition, the transmission has the advantage that the transmission is simply designed, and so the design complexity of the transmission is low.

The transmission housing may be an integral part of the bottom bracket shell, i.e., may be designed as one piece with the bottom bracket shell. Alternatively, the transmission housing may be a housing separate from the bottom bracket shell, which may be introduced into a cavity of the bottom bracket shell. The transmission housing may be designed and arranged in such a way that the transmission housing does not rotate during the operation of the transmission, but rather is stationary.

A shaft is not understood exclusively to be a, for example, cylindrical, rotatably mounted machine element for transmitting torques. Rather, shafts are also to be understood to be general connecting elements which connect individual components to one another, in particular connecting elements which connect multiple components to one another in a rotationally fixed manner.

The planetary gear stages all encompass a gear teeth section which may be brought into engagement with at least one other element of the planetary gear set. The individual planetary gear stages differ from one another in terms of their diameters. The planet gear is carried by a carrier of the first planetary gear set.

In the transmission according to example aspects of the invention, the first gear may have a ratio of one (1) or slightly greater than one (1). Starting with the second gear, a speed increasing ratio is implemented, i.e., the ratio has a value less than one (1). With the aid of the transmission according to example aspects of the invention, at least eight, in particular precisely eight, gears can be realized. This is possible since two gears can be realized with the aid of each of the planetary gear sets.

The transmission according to example aspects of the invention also has the advantage that the transmission can be very particularly easily expanded with the aid of slight retrofitting or modifications. In particular, the transmission can be expanded from an 8-speed transmission to a closely stepped 12-speed transmission. This can be realized due to the fact that a third planetary gear stage is added to the planet gear of the first planetary gear set. A third ring gear, which is engaged with a gear teeth section of the third planetary gear stage, may be rotationally fixable to the transmission housing with the aid of a third shift element. In this way, the transmission according to example aspects of the invention can be expanded from an 8-speed transmission to a 12-speed transmission in a very particularly simple way.

The element of the first planetary gear set is a carrier which carries the planet gears. The carrier may also carry multiple planet gears, of course. A sun gear of the first planetary gear set may be rotationally fixed to a carrier of the second planetary gear set. In particular, the sun gear of the first planetary gear set, which is engaged with the first planetary gear stage, may be rotationally fixed to the carrier of the second planetary gear set.

A sun gear of the second planetary gear set may be rotationally fixable to the transmission housing with the aid of a fourth shift element. In addition, two elements of the second planetary gear set may be rotationally fixable to one another with the aid of a fifth shift element. As a result, an interlock of the second planetary gear set can be achieved. During an interlock, the planetary gear set has a ratio of one (1). In particular, the fifth shift element may be arranged in such a way that a ring gear of the second planetary gear set is rotationally fixable to the sun gear of the second planetary gear set. The fifth shift element may also be arranged differently, of course, so that the ring gear of the second planetary gear set may be rotationally fixed to the carrier of the second planetary gear set, or the carrier of the second planetary gear set may be rotationally fixed to the sun gear of the second planetary gear set.

Moreover, the ring gear of the second planetary gear set may be rotationally fixed to a sun gear of the third planetary gear set. A ring gear of the third planetary gear set may be rotationally fixable to the transmission housing with the aid of a sixth shift element.

In addition, two elements of the third planetary gear set may be rotationally fixable to one another. As a result, an interlock of the third planetary gear set can be achieved. It is very particularly advantageous when the seventh shift element is arranged in such a way that the ring gear of the third planetary gear set is rotationally fixable to the sun gear of the third planetary gear set. An arrangement of the seventh shift element is also possible, of course, in which the ring gear of the third planetary gear set may be rotationally fixed to the carrier of the third planetary gear set, or the carrier of the third planetary gear set may be rotationally fixed to the sun gear of the third planetary gear set.

An element of the third planetary gear set may be rotationally fixed to a transmission output shaft. In particular, the carrier of the third planetary gear set may be rotationally fixed to the transmission output shaft. The transmission output shaft may be rotationally fixed to a traction mechanism carrier, such as a sprocket or a belt pulley. The torque provided by the transmission can be transmitted to a rear wheel of the bicycle via the traction mechanism carrier and a traction mechanism, such as a chain or a belt.

In the end, a simply designed transmission is made available, which may include precisely three planetary gear sets and with the aid of which a plurality of gear ratios can be realized or implemented. In addition, the planet gear of the first planetary gear set may include precisely three planetary gear stages. In particular, the transmission has the advantage that the sixth shift element is not strongly loaded and a small supporting torque is applied to the sun gear.

The first and/or the second and/or the third planetary gear set(s) may be designed as a minus planetary gear set. Alternatively, it is conceivable that the first and/or the second and/or the third planetary gear set(s) are/is designed as a plus planetary gear set.

A minus planetary gear set corresponds to a planetary gear set that includes a carrier, on which the planetary gears are rotatably mounted, and that includes a sun gear and a ring gear, wherein the tooth system of at least one of the planetary gears intermeshes with the tooth system of the sun gear as well as with the tooth system of the ring gear, whereby the ring gear and the sun gear rotate in opposite directions of rotation when the sun gear rotates while the carrier is held. In contrast thereto, a plus planetary gear set differs from the minus planetary gear set in that the plus planetary gear set includes inner and outer planetary gears which are rotatably mounted on the carrier. The tooth system of the inner planetary gears intermeshes, in this case, with the tooth system of the sun gear, on the one hand, and with the tooth system of the outer planetary gears, on the other hand. In addition, the tooth system of the outer planetary gears intermeshes with the tooth system of the ring gear. As a result, the ring gear and the sun gear rotate in the same direction of rotation when the carrier is held.

During the traction operation of the transmission, the planetary gear sets of the transmission are arranged in the sequence first planetary gear set, second planetary gear set, and third planetary gear set. The first, second, third, fourth, and sixth shift elements may be designed as brakes. The fifth and seventh shift elements may be designed as a clutch.

In one very particular embodiment, the transmission may include an electric machine which is operatively connected or may be operatively connected to the transmission output shaft. The electric machine may be drivingly connected downstream from the first and/or the second and/or the third planetary gear set(s). This offers the advantage that the torque provided by the electric machine does not act on the planetary gear sets. The electric machine also has the advantage that the electric machine can assist the cyclist in the operation. As a result, close gear steps are not necessary, since, due to the electric machine, muscle power has little significance for the propulsion.

The electric machine includes at least of a rotationally fixed stator and a rotatably mounted rotor and is configured for converting electrical energy into mechanical energy in the form of rotational speed and torque when operated as a motor and for converting mechanical energy into electrical energy in the form of current and voltage when operated as a generator.

The electric machine may be arranged so as to be offset, in particular in the radial direction, with respect to a central axis of the transmission and/or the crankshaft. In particular, a central axis of the electric machine may extend in parallel to a central axis of the transmission. This offers the advantage that the electric machine may be arranged in an area of the bottom bracket, in which sufficient space is available for accommodating the electric machine. In addition, an inner diameter of the electric machine may be freely selected, since the crankshaft, which does not belong to the transmission, does not extend through the electric machine.

The electric machine may be operatively connected or, with the aid of an eighth shift element, operatively connectable to the transmission output shaft with the aid of a spur gear drive and/or a belt drive and/or a differential drive. The eight shift element may be a free-wheel unit in this case. Therefore, it is ensured that, during an operation without the electric machine, no losses are caused by the concurrently-rotating motor of the electric machine.

The transmission may be modularly designed. This means, the electric machine and the planetary gear sets are integrated, as a functional unit, into the bottom bracket shell and/or may be introduced into or removed from the bottom bracket shell as a functional unit.

A bottom bracket that includes a transmission is particularly advantageous. The transmission input shaft may be rotationally fixed to the crankshaft. In particular, the bottom bracket may include a bottom bracket shell, wherein the transmission may be arranged within the bottom bracket shell, in particular in a cavity of the bottom bracket shell. A bicycle that includes the transmission or the bottom bracket is very particularly advantageous.

### BRIEF DESCRIPTION OF THE DRAWINGS

The subject matter of examples aspects of the invention is schematically represented in the figures and is described in the following with reference to the figures, wherein identical or identically operating elements are mostly provided with the same reference characters. Wherein:

FIG. 1 shows a schematic of the transmission according to the invention, according to a first exemplary embodiment;

FIG. 2 shows a table of values for the stationary transmission ratio;

FIG. 3 shows a shift pattern for the transmission represented in FIG. 2; and

FIG. 4 shows a schematic of the transmission according to the invention, according to a second exemplary embodiment.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

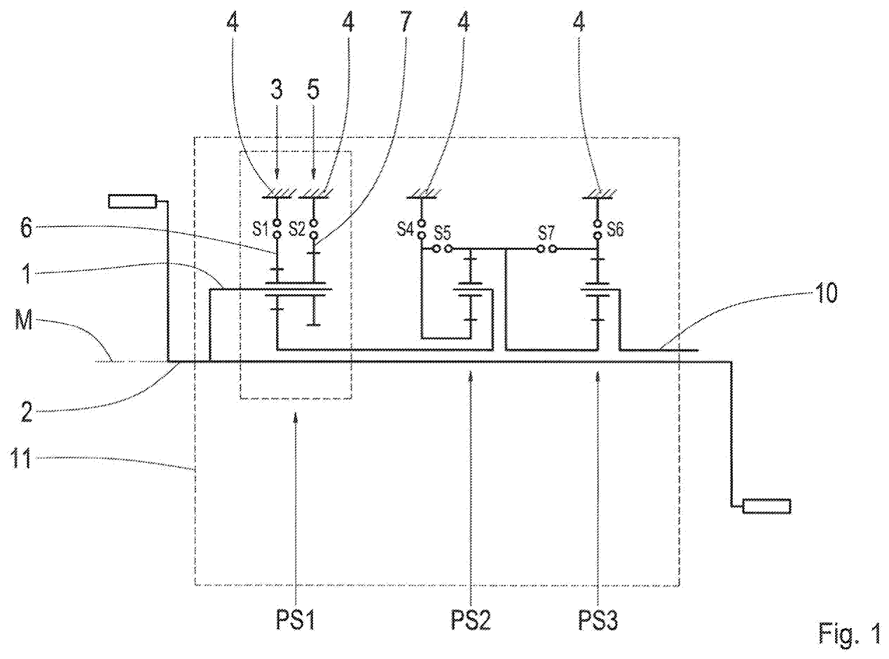

The transmission represented in FIG. 1 is designed to be rotationally symmetrical with respect to a central axis M of the transmission, whereby only the upper half of the transmission is represented. The transmission includes a transmission input shaft 1 which is rotationally fixed to a crankshaft 2. The crankshaft 2 includes a pedal at each of end of the crankshaft 2. In addition, the transmission includes a first planetary gear set PS1, a second planetary gear set PS2, and a third planetary gear set PS3, which are operatively connected to one another. A carrier of the first planetary gear set PS1 is rotationally fixed to the transmission input shaft. The first planetary gear set PS1 includes a planet gear having a first planetary gear stage 3 and a second planetary gear stage 5.

A first ring gear 6 is engaged with the first planetary gear stage 3 and is rotationally fixable to a transmission housing 4 with the aid of a first shift element S1. A second ring gear 7 is engaged with the second planetary gear stage 5 and is rotationally fixable to the transmission housing 4 with the aid of a second shift element S2.

A sun gear of the first planetary gear set PS1, which is engaged with the first planetary gear stage PS1, is rotationally fixed to a carrier of the second planetary gear set PS2. A sun gear of the second planetary gear set P2 is rotationally fixable to the transmission housing 4 with the aid of a fourth shift element S4. In addition, the sun gear of the second planetary gear set PS2 is rotationally fixable to a ring gear of the second planetary gear set PS2 with the aid of a fifth shift element S5. Moreover, the ring gear of the second planetary gear set PS2 is rotationally fixed to a sun gear of the third planetary gear set PS3.

A ring gear of the third planetary gear set PS3 is rotationally fixable to the transmission housing 4 with the aid of a sixth shift element S6. In addition, the ring gear of the third planetary gear set PS3 is rotationally fixable to the sun gear of the third planetary gear set PS3 with the aid of a seventh shift element S7. A carrier of the third planetary gear set PS3 is rotationally fixed to a transmission output shaft 10.

The planetary gear sets are arranged coaxially to the central axis M of the transmission and/or the crankshaft 2. In addition, the transmission output shaft 10 is arranged coaxially to the central axis M of the transmission and/or the crankshaft 2. The transmission is arranged in a cavity of a bottom bracket shell 11 of a bottom bracket of a bicycle (not represented).

The transmission output shaft 10 is rotationally fixed to a traction mechanism carrier which is not represented in the figures. The traction mechanism carrier may be, for example, a sprocket or a belt pulley and is utilized for transmitting the torque output by the transmission to a rear wheel (not represented).

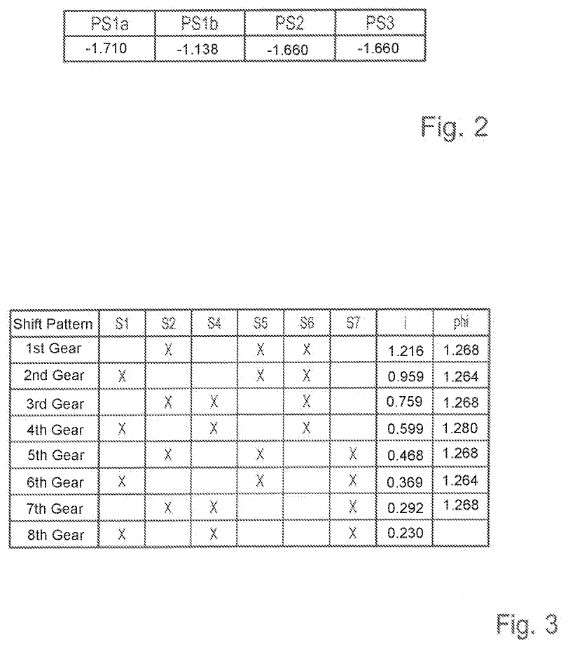

FIG. 2 shows the values for the stationary transmission ratio. In this case, PS1a indicates the stationary transmission ratio for the first planetary gear set PS1 with respect to the first planetary gear stage 3 and PS1b indicates the stationary transmission ratio for the first planetary gear set PS1 with respect to the second planetary gear stage 5. As is apparent from the table, the second planetary gear set PS2 and the third planetary gear set PS3 have the same stationary transmission ratio.

FIG. 3 shows the shift pattern of the transmission represented in FIG. 1. In addition, the table shows the ratio “i” for the individual gears between the transmission input shaft 1 and the transmission output shaft 10. The ratio steps “phi” are also shown in the table. The letter “x” indicates that the particular shift elements are engaged. It is clear from FIG. 3 that the transmission has eight gears.

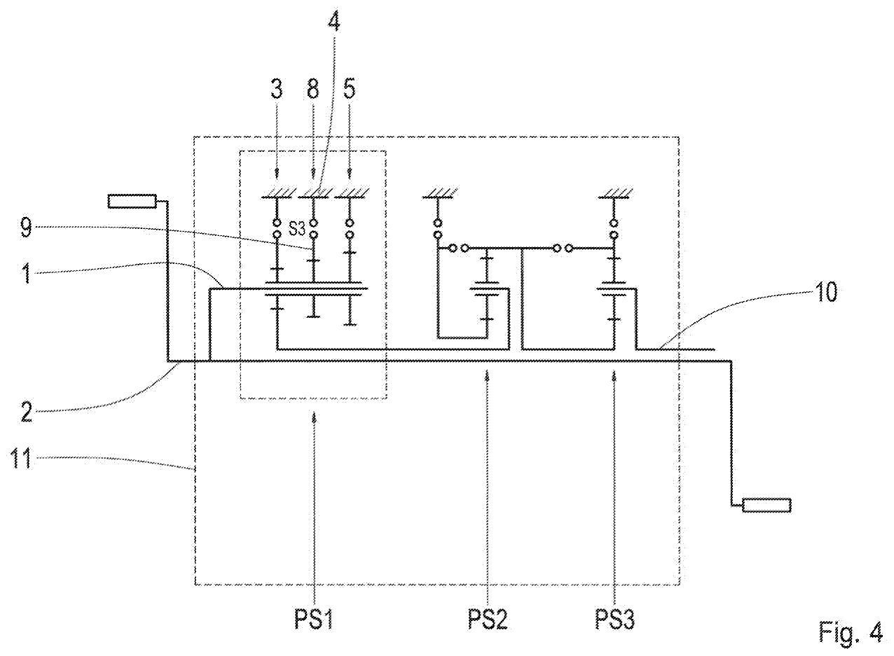

The transmission represented in FIG. 4 differs from the transmission represented in FIG. 1 in that the planet gear of the first planetary gear set PS1 encompasses a third planetary gear stage 8. A third ring gear 9 is engaged with the third planetary gear stage 8 and may be rotationally fixable to the transmission housing 4 with the aid of a third shift element S3. The diameter of the third planetary gear stage 8 is larger than the diameter of the first planetary gear stage 3 and is smaller than the diameter of the second planetary gear stage 5.

Modifications and variations can be made to the embodiments illustrated or described herein without departing from the scope and spirit of the invention as set forth in the appended claims.

### REFERENCE CHARACTERS

1 transmission input shaft
2 crankshaft
3 first planetary gear stage
4 transmission housing
5 second planetary gear stage
6 first ring gear
7 second ring gear
8 third planetary gear stage
9 third ring gear
10 transmission output shaft
11 bottom bracket shell
M central axis
S1 first shift element
S2 second shift element
S3 third shift element
S4 fourth shift element
S5 fifth shift element
S6 sixth shift element
S7 seventh shift element
PS1 first planetary gear set
PS2 second planetary gear set
PS3 third planetary gear set

1-15. (canceled)

16. A transmission for a bicycle, comprising:
a transmission input shaft (1) rotationally fixable to a crankshaft (2);
a first planetary gear set (PS1), a second planetary gear set (PS2), and a third planetary gear set (PS3), which are operatively connected to one another,
wherein an element of the first planetary gear set (PS1) is rotationally fixed to the transmission input shaft (1),
wherein the first planetary gear set includes a planet gear with a first planetary gear stage (3) and a second planetary gear stage (5),
wherein a first ring gear (6), which is engaged with a gear teeth section of the first planetary gear stage (3), is rotationally fixable to a transmission housing (4) with a first shift element (S1), and
wherein a second ring gear (7), which is engaged with a gear teeth section of the second planetary gear stage (5), is rotationally fixable to the transmission housing (4) with a second shift element (S2).

17. The transmission of claim 16, wherein:
the planet gear of the first planetary gear set (PS1) has a third planetary gear stage (8); or
the planet gear of the first planetary gear set (PS1) has a third planetary gear stage (8), and a third ring gear (9), which is engaged with a gear teeth section of the third planetary gear stage (8), is rotationally fixable to the transmission housing (4) with a third shift element (S3).

18. The transmission of claim 16, wherein the element of the first planetary gear set (PS1) is a carrier.

19. The transmission of claim 16, wherein:
a sun gear of the first planetary gear set (PS1) is rotationally fixed to a carrier of the second planetary gear set (PS2); or
a sun gear engaged with the first planetary gear stage (3) is rotationally fixed to the carrier of the second planetary gear set (PS2).

20. The transmission of claim 16, wherein a sun gear of the second planetary gear set (PS2) is rotationally fixable to the transmission housing (4) with a fourth shift element (S4).

21. The transmission of claim 16, wherein two elements of the second planetary gear set (PS2) are rotationally fixable to each other with a fifth shift element (S5).

22. The transmission of claim 16, wherein a ring gear of the second planetary gear set (PS2) is rotationally fixed to a sun gear of the third planetary gear set (PS3).

23. The transmission of claim 16, wherein a ring gear of the third planetary gear set (PS3) is rotationally fixable to the transmission housing (4) with a sixth shift element (S6).

24. The transmission of claim 16, wherein two elements of the third planetary gear set (PS3) are rotationally fixable to each other with a seventh shift element (S7).

25. The transmission of claim 16, wherein a carrier of the third planetary gear set (PS3) is rotationally fixed to a transmission output shaft (10).

26. The transmission of claim 25, further comprising an electric machine operatively connected or operatively connectable to the transmission output shaft (10).

27. The transmission of claim 26, wherein the electric machine is operatively connected or is operatively connectable with an eighth shift element to the transmission output shaft via one or more of a spur gear drive, a belt drive, and a differential drive.

28. The transmission of claim 16, wherein:
a sun gear of the second planetary gear set (PS2) is rotationally fixable to the transmission housing (4) with a fourth shift element (S4);
two elements of the second planetary gear set (PS2) are rotationally fixable to each other with a fifth shift element (S5);
a ring gear of the second planetary gear set (PS2) is rotationally fixed to a sun gear of the third planetary gear set (PS3);
a ring gear of the third planetary gear set (PS3) is rotationally fixable to the transmission housing (4) with a sixth shift element (S6);
two elements of the third planetary gear set (PS3) are rotationally fixable to each other with a seventh shift element (S7); and
a carrier of the third planetary gear set (PS3) is rotationally fixed to a transmission output shaft (10).

29. A bottom bracket, comprising the transmission of claim 16 and a crankshaft, wherein the transmission input shaft (1) is rotationally fixed to the crankshaft (2).

30. The bottom bracket of claim 29, further comprising a bottom bracket shell (11), wherein the transmission is arranged within a cavity of the bottom bracket shell (11).

31. A bicycle comprising the transmission of claim 16.

32. A bicycle, comprising the bottom bracket of claim 29.
